(19) United States
(12) Patent Application Publication
(10) Pub. No.: US 2006/0101392 A1
(43) Pub. Date: May 11, 2006

(54) Strongly-typed UI automation model generator

(75) Inventor: Gonzalo Isaza, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 10/974,183

(22) Filed: Oct. 27, 2004

(51) Int. Cl. G06F 9/44

(52) U.S. Cl. 717/108; 717/110

(57) ABSTRACT

The subject invention provides a unique system and method that facilitates automation of UI used in conjunction with testing applications. The system and method involve gathering information about various controls including the control IDs, controls types, and control locations within a particular dialog or window. A strongly-typed class can be generated according to the gathered information and can include properties and/or methods to access each of the controls. The corresponding code for the strongly-typed class can be generated automatically in any managed language. The appearance of the code can be enhanced by organizing logical parts into regions, removing undesired blank lines, and including comments where appropriate.

### TECHNICAL FIELD

The subject invention relates generally to developing programs and in particular, to ease the process of automating application testing procedures to improve consistency and accuracy of applications and programs.

### BACKGROUND OF THE INVENTION

As applications or software programs are developed, they typically undergo various stages of testing to determine their operability and accuracy. UI testing is aided usually by a class library, which helps drive automation for UI objects, such as, for example, clicking on buttons, typing on textbox controls, selecting items from lists, etc.

When the elements present in a dialog box or other application window need to be tested, Test Engineers must write large amounts of code to create classes for various dialogs. Traditionally, users had no other choice but to write the code manually for each desired dialog (or window under test). Naturally, there can be great amounts of inconsistency and undesirable variations among different testers. In addition, much of a tester's time may be consumed by writing the large amounts of code that is required or necessary to test an application. Thus, testing and fine tuning applications can be a rather inefficient process.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention relates to a system and/or methodology that facilitate generating classes and their related code in an automated fashion for any desired dialog (or window under test) to reduce the amount of time testers spend testing applications. A “dialog” can refer to an interface that a user would use to create a certain function for an application or program. In particular, the system and/or method of the invention provide a tool that can automatically generate a class for a desired dialog and the respective code quickly and accurately without substantial user involvement (e.g., manual code writing, etc.). This can be accomplished in part by initially selecting a dialog for which automation is desired, extracting and analyzing several different types of information from the dialog and finally, generating a class which defines and encapsulates the behavior of the dialog to be tested. Once a strongly-typed class is determined, the code can be generated for use in a localized application as well as in different languages for other applications. The generated strongly-typed class can include a plurality of properties that can be used to access one or more controls associated with the class. In the end, a richer, more robust class library can be built and made available to application testers.

According to one aspect of the invention, a strongly-typed classification tool and/or its sub-components can search for all of the controls, windows, and control types such as checkboxes, radio buttons, browse buttons, edit boxes, etc. associated with the dialog and then extract them along with other types of available information—including but not limited to accessible names, control IDs, location, position of control within a window hierarchy, and/or HTML controls. Once all the relevant information is gathered, these items can be created. For example, if the user wants to have a particular radio button automatically selected, the generated code can includes a member property matching the radio button, which will allow the tester to select the button by issuing just on line of code.

According to another aspect of the invention, the user can specify where to look for any of this information. For example, a specific subdirectory can be searched for resource IDs. Conventional practices employ the string that corresponds to the resource ID. In the subject invention, however, the resource ID for that desired string can be employed instead. By using the resource ID for a particular string instead of the string itself in the generated code, the resulting test can make use of the generated code in the localized version as well as across different languages.

According to yet another aspect of the invention, controls, properties, and/or methods of a generated class can be given human-readable names that are intuitive and descriptive of their environment. To accomplish this, the tool or its subparts can look for and examine surrounding labels of a given control to provide context and relevance to the various control, property, and/or method names.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a system that automates class and code generation corresponding to a desired UI element in accordance with an aspect of the subject invention.

FIG. 2 is a block diagram of a system that automates class and code generation corresponding to a desired UI element in accordance with another aspect of the subject invention.

FIG. 3 illustrates an exemplary user interface of a dialog display for which a strongly-typed class and code can be automatically generated in accordance with an aspect of the subject invention.

FIG. 4 illustrates an exemplary user interface of a dialog display for which a strongly-typed class and code can be automatically generated in accordance with an aspect of the subject invention.

FIG. 5 is a flow chart illustrating an exemplary methodology that facilitates classifying a UI element and generating code in an automated fashion in accordance with an aspect of the subject invention.

FIG. 6 is a flow chart illustrating an exemplary methodology that facilitates classifying a UI element and generating code in an automated fashion in accordance with an aspect of the subject invention.

FIG. 7 illustrates an exemplary environment for implementing various aspects of the invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

The subject invention can incorporate various inference schemes and/or techniques in connection with generating a strongly-typed class for any particular UI element of dialog. In particular, inference schemes can learn which associations of controls most suitably match to a particular strongly-typed class. Likewise, the various inference schemes can learn from mistaken classifications in part from users or testers who later use the strongly-typed class to write tests. Thus, test efficacy and/or user feedback can be provided to assist or influence future generations of strongly-typed classes.

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Traditionally, code generation tools for automation generated “recorded scripts” that mimic user interactions with a user interface (UI). Testers, such as those that test application products, often make use of or rely upon this automation framework to test applications but typically must expend excessive amounts of time manually writing classes that abstract nearly every dialog in the products they are testing. To mitigate the substantial amounts of manual coding time as well as to improve consistency and overall robustness of the generated classes, the subject invention can query the UI for its elements to ultimately generate a strongly-typed class that encapsulates the UI and automatically hooks up one or more controls by determining their unique identifiers in an automated fashion.

More specifically, the UI of the subject invention can allow a user to specify a UI element and then can locate the ancestor window. Once found, the controls present in the window can be extracted and analyzed to facilitate determining an appropriate strongly-typed class for the UI element. By generating the strongly-typed class, properties can be associated with the particular controls to allow for easier access to each of the controls. Additionally, control types can be identified by analyzing groups of sub-controls. Examples of UI elements include but are not limited to clicking on an object, expanding a tree control, double clicking to select an object, typing in a field or box, a scroll bar, etc . . . .

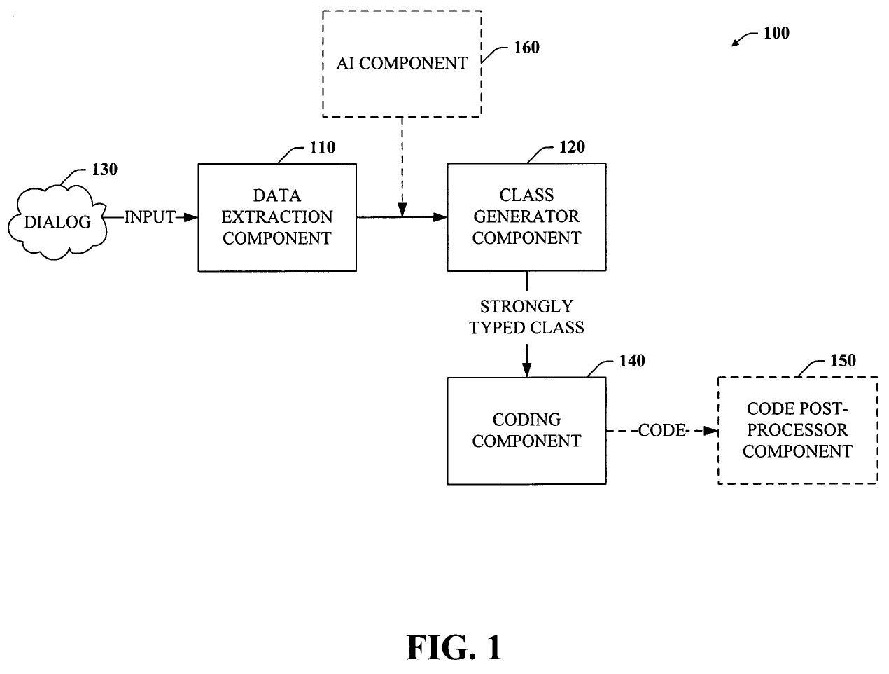

Dialogs can be used to drive the testing of any UI element and automation can be created for any desired dialog. In the past, testers had to write code manually for each class for every dialog which roughly equates to large amounts of manually created code. Fortunately, one aspect of the subject invention provides for the automatic generation of the code for any particular class in CodeDom (e.g., C# and vb) and/or XML in any managed language. This aspect as well other aspects of the subject invention will now be discussed in greater detail with reference to FIGS. 1-6 below.

Referring to FIG. 1, there is a general block diagram of a strongly-typed classification system 100 in accordance with an aspect of the subject invention. The system 100 includes a data extraction component 110 and a class generator component 120. A user can select a UI element or dialog 130 for which automation is desired and then can introduce the particular UI element or dialog 130 to the data extraction component 110. The dialog may appear in the form of a window, for example. The data extraction component 110 can extract various types of data from the window such as the types of controls, their unique IDs, and their locations. All of the functionality of a dialog is encapsulated within a class. As a result, a strongly-typed class can be generated by analyzing the extracted data. This can be performed by the class generator component 120.

When generating the class, properties of any controls can be named to facilitate determining the purpose of the controls. This can result in a very human-readable class that is intuitive to use. More specifically, the data extraction component 110 can examine an area surrounding a control for any other labels associated with the control at runtime. For example, imagine that a tree control is found. In order to give it a meaningful name, the data extraction component 110 can look around the control. If it finds the label “directory structure” above the tree control, then it can assign the name: directory structure tree control. Furthermore, the data extraction component 110 can or at least attempt to discover the functionality of the found tree control based on the surrounding labels. Once the data extraction component 110 locates the necessary information for all or substantially all of the controls, then a strongly-typed class can be generated by the class generator component 120.

Following therefrom, a coding component 140 can automatically generate the corresponding code for the strongly-typed class in any managed language such as C#, vb, and/or XML. Optionally, a code post processing component 150 can be employed to beautify the code. For instance, the code can be organized into regions according to its logical parts, comments can be added, and/or blank lines can be removed.

The system 100 provides for a more uniform and richer class library that mitigates undesirable variations caused by disparate individuals writing code according to their personal techniques. The class library can be utilized to test applications. Thus, when a tester needs to drive specific parts of an application, the system 100 can generate the code to accomplish this quicker. For example, given that all of the behaviors of the controls are encapsulated in a class, instead of discovering all the information for a particular dialog, the tester can type: MyDialog.OutputLanguage radio button=foo (wherein “MyDialog” is a class name and represents the code generated by the system 100; and Output Language radio group identifies a UI element comprising a group of radio buttons labeled Output Language). As a result, radio button labeled “foo” can be selected automatically. The same can apply to any other type of UI element, whereby the designated string (e.g., foo) can be automatically entered or selected for the particular UI element.

Next, imagine that the class library has knowledge of a listbox. Suppose that a control creates a listbox object within the dialog (strongly-typed) class. Because the library understands the listbox object, it performs all the necessary handling when the listbox is used. Therefore, the class library can be said to be tightly coupled to the object due to the strongly-typed classification.

To further enhance the system 100, an optional AI (artificial intelligence) component 160 can be employed to facilitate the class generator component 120. In particular, the AI component can learn from misclassifications and mistakes that are made such as when identifying controls and naming control properties to avoid making such mistakes in the future. Similarly, the AI component can learn from its successful classifications and naming conventions employed when looking at surrounding labels of a control. As a result, naming properties or methods can be optimized. Furthermore, the AI component 160 can also be taught one or more rules to follow during the class generation process as desired by the user.

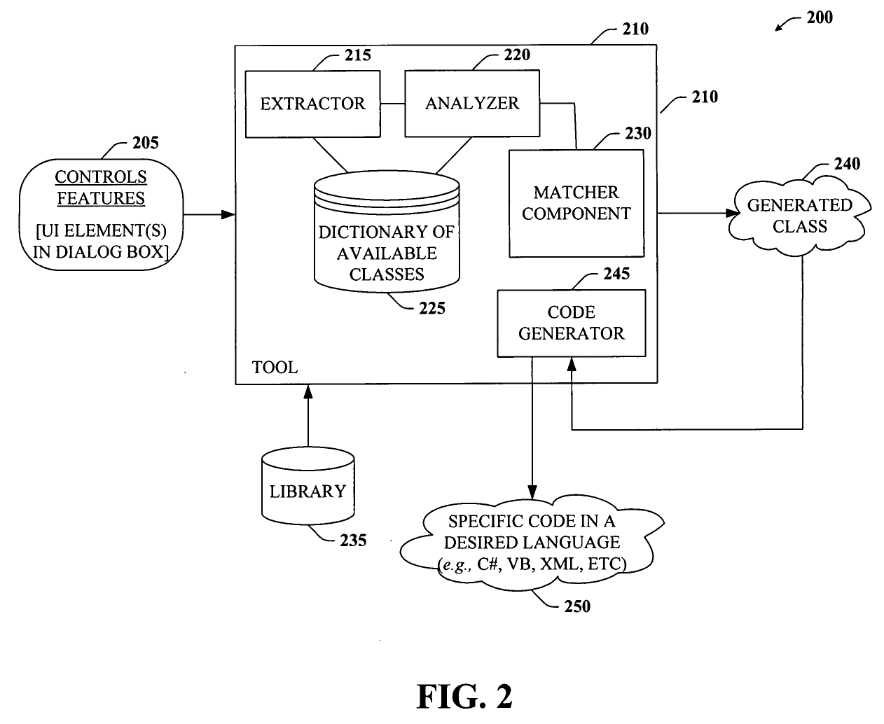

Moving on to FIG. 2, there is illustrated a block diagram of a class generation system 200 that facilitates automatic strongly-typed classification of UI elements in accordance with an aspect of the invention. The system 200 includes a dialog 205 comprising controls or features that can be introduced into an automation tool 210 to automate the functionalities associated with the dialog 205. The tool 210 includes an extractor 215 that can look for all types of available information and/or resources including but not limited to controls, windows, control types, check boxes, radio buttons, combo boxes, accessible names or labels, control IDs, location of controls, window position, control types, etc . . . .

In addition, a user can specify where the extractor 210 can or should look for resources. For example, the extractor can search specified sub-directories. Instead of picking and using a particular string (e.g., all DLL files can be searched for that string and the appropriate resource ID can be employed in place of the string in the generated code. One distinct advantage to this practice is that the generated strongly-typed class can be utilized in any language (e.g., English, Spanish, Italian, Chinese . . . ) since hard-coded strings are replaced with their corresponding resource IDs. By way of example, suppose that a user wants to find resource ID 2035 in foo.dll. The extractor 215 would locate the DLL file (e.g., foo.dll), extract resource ID 2035, and then pick the string located therein. If running on an English product, the English string can be obtained. However, if the English code instructed only to extract the string and not the resource ID, then the class would only be useful to the localized application (or product) and not to other language versions of that application. Thus, by including the resource IDs in the generated code rather than the specific strings, the generated code can be useful for testing the localized product as well as other language versions of the product. Alternatively, strings can be obtained when desired by the tester or user.

The system 200 also includes an analyzer 220 that can analyze the information collected by the extractor 215 in conjunction with a dictionary 225 of available classes (e.g., window classes). The dictionary 225 defines classes according to the associations among or between different controls. Thereafter, a matching component 230 that can then map the class (of the window) it finds in the dictionary 225 with the closest control of that type.

Unlike classes of windows which are named in a nonsensical alphanumeric format (e.g., Win forms named such as “6.8.edit”), a library 235 includes and defines substantially all class names in human terms such as textbox, edit box, combo box, etc . . . . Hence, when the tool 210 determines an appropriate complex class name (selected from the dictionary 225), it can map it to the closest match in the library 235 to yield a strongly-typed class 240 for the dialog. The strongly-typed class 240 includes a plurality of properties to facilitate accessing each of the controls. The strongly-typed class 240 can also identify control types based analysis of control sub-groups or sub-directories.

When the strongly-typed class is determined, the corresponding code can be automatically generated by a code generator 245 to yield the specific code 250. The code 250 can be written in any desired language. Thus, the tool 210 or the system 200 in general is not limited to particular applications, products, or languages.

To further illustrate the behavior of the tool 210, consider the following scenario. When presented with a dialog or set of UI elements to automate, the tool 210 “goes inside” and for each window it finds, the tool 210 can collect a class name and a control ID to determine if the control is native or managed or HTML, and can identify labels in the surrounding area of each control to provide meaningful names to the control properties or methods.

In addition, the tool 210 can search to identify potential complex situations to prevent from getting fooled and to mitigate performing unnecessary work. For example, imagine that there is an edit combo box (e.g., click to reveal options or type own choice in the box) present in the window. The edit combo box is actually made up of two controls: the edit control and the combo box. Therefore, the tool 210 can notice that an edit control is present in the combo box and identify it as an edit combo box. As a result, only one control will be generated for the whole box—instead of two. Another complex situation arises when a scroll bar having up and down arrows is present such as next to a listing of numbers. The up/down arrows are typically two or three controls. The tool 210 can identify all the relevant controls and then generate code for only the necessary controls as the case may be. In general, fewer controls may need to be generated; thus minimizing the amount of code.

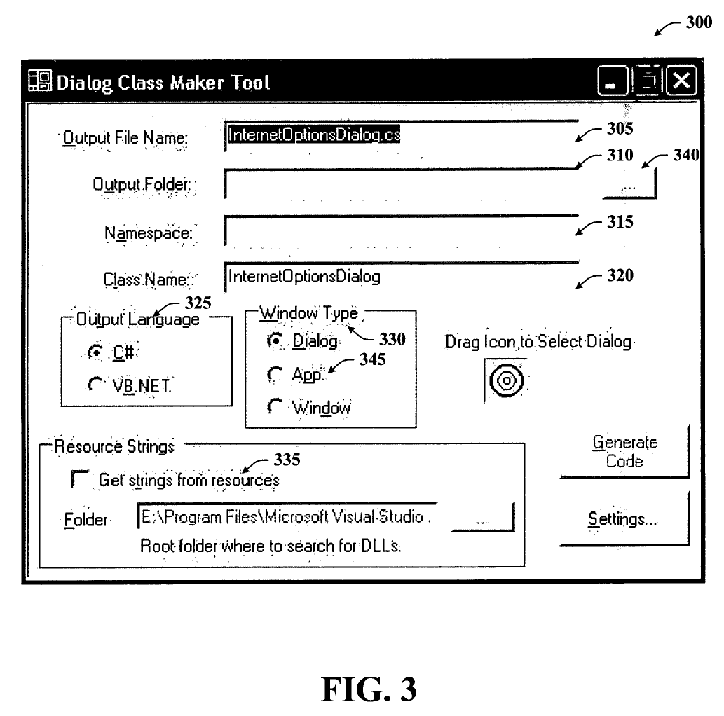

Referring now to FIG. 3, there is illustrated an exemplary dialog 300 in accordance with an aspect of the subject invention. Imagine that a user wishes to automate this dialog 300. Based on the information evaluated in the dialog 300, a class generation tool or system can create a strongly-typed class to facilitate automation of desired UI elements or of dialogs. The class includes information for all the controls and other various supports. In the dialog 300, a class generation tool, system, or some part thereof can find any controls, control IDs, window position of controls, and the like which are present in the dialog 300. For example, a textbox 305 can be found and named output file textbox 305. The same can occur with respect to an output folder textbox 310, a namespace textbox 315, and a class name textbox 320.

As shown in the figure, it can also find a group of two radio buttons and then can name the group output language type radio group 325—based on the label found in the proximity of the radio buttons. Similarly, a window type radio group 330 can be named as such. A “get strings from resources” check box 335 and a browse button 340 that can be recognized by the series of three periods can be found as well. In addition, the user can also specify the resources the tool should or can search by selecting sub-directories. Once all the necessary information is at-hand, a “generate code” button can be pushed to generate the code for the class.

Assuming that the code for this dialog 300 has been generated (e.g., identified by class name: MyDialog), consider that the user would like to automate a selection of the App radio button 345 in the Window Type radio group 330. To accomplish this, a line of code could reflect the following: MyDialog. Window Type RB=App (wherein MyDialog identifies the strongly-typed class; Window Type identifies the control; and App is the string). With this line of code, App can be automatically selected in the dialog 300. When controls are modified or added to a strongly-typed class or when any behavior is added to the dialog, the tool can regenerate the class to update the class library.

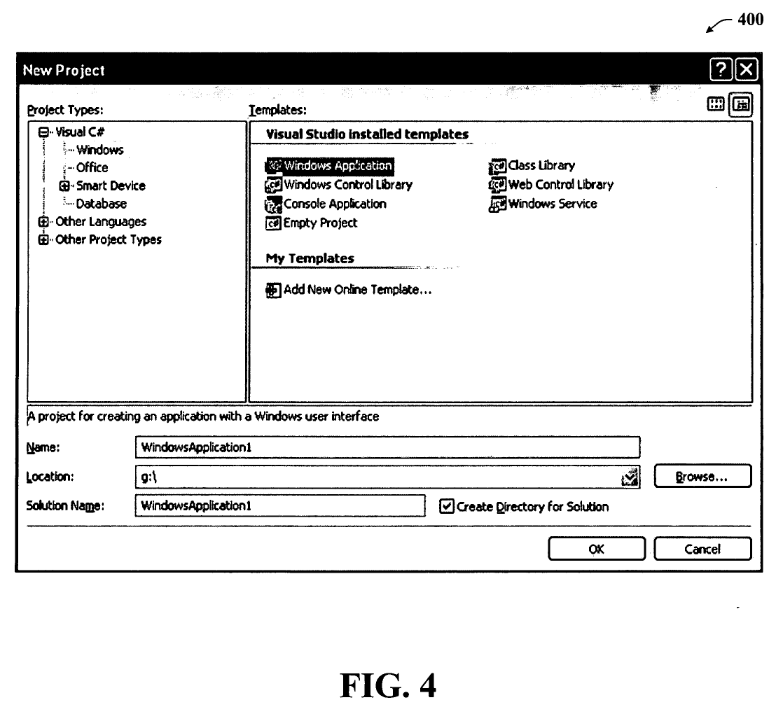

Turning to FIG. 4, there is illustrated an exemplary dialog 400 that can be employed in application development programs. Attached and identified as Appendix A is approximately 15 pages of code that the automation tool or system (see e.g., FIG. 1 or 2) can write for an application tester. The generated code even includes comments and code that can compile perfectly. As can be seen, the various controls are named by analyzing the labels around each of them. Consequently, the names of the controls tend to make more sense and as a result, the need to subsequently rename them is mitigated. Additionally, a user can generate the code in VB, C#, and/or XML depending on the user's needs or preferences.

Various methodologies in accordance with the subject invention will now be described via a series of acts, it is to be understood and appreciated that the subject invention is not limited by the order of acts, as some acts may, in accordance with the subject invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

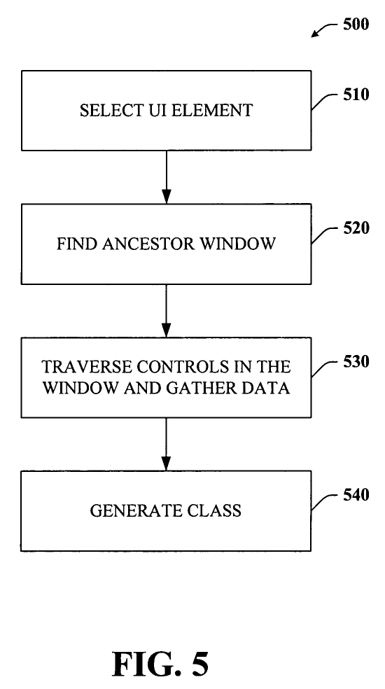

Referring now to FIG. 5, there is a flow diagram of an exemplary process 500 that facilitates strongly-typed class creation for a set of UI elements in accordance with an aspect of the invention. The process involves selecting one or more UI elements for which automation is desired at 510. At 520, an ancestor window corresponding to the UI elements can be found. At 530, the process can traverse one or more controls in the window and gather the corresponding data about the controls such as control IDs, location of controls, types of controls, hierarchy in the window, and the like. At 540, a strongly-typed class can be generated that encapsulates the functionality of the UI and the various controls present therein.

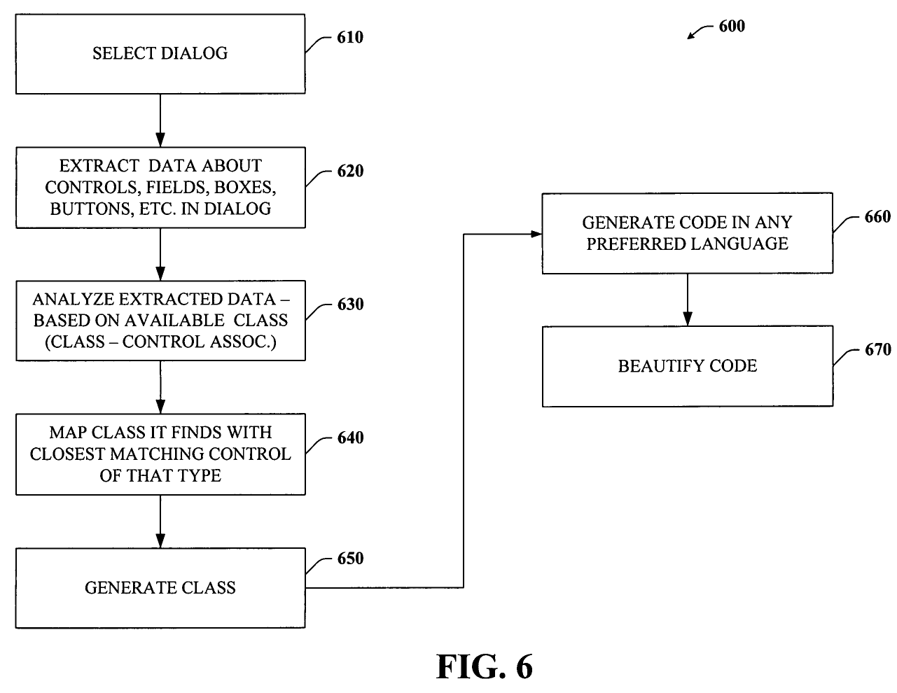

Referring now to FIG. 6, there is a flow diagram of an exemplary process 600 that facilitates generating strongly-typed classes for a dialog or other set of UI elements such as a “file-open” dialog in accordance with an aspect of the invention. The process 600 involves selecting the appropriate dialog for which automation is desired at 610. This can be accomplished by dragging an automation icon to the appropriate dialog. At 620, relevant data can be extracted from the dialog window(s) relating to any controls, fields (e.g., textbox, check box, etc.). At 630, the extracted data can be analyzed in part by looking at class-control associations. In particular, the controls can be associated with or matched to a class (that is most closely related to the control) at 640. At 650, the process can generate a strongly-typed class having properties that facilitate accessing the controls. At 660, the code can be generated in any suitable computer related language such as C#, VB, and/or XML, for example. Finally, at 670, the code can be beautified. For example, related controls can be grouped together or by region to make it easier to read. Logical parts of the code can be reorganized, undesirable blank lines can be removed, and comments can be added as well.

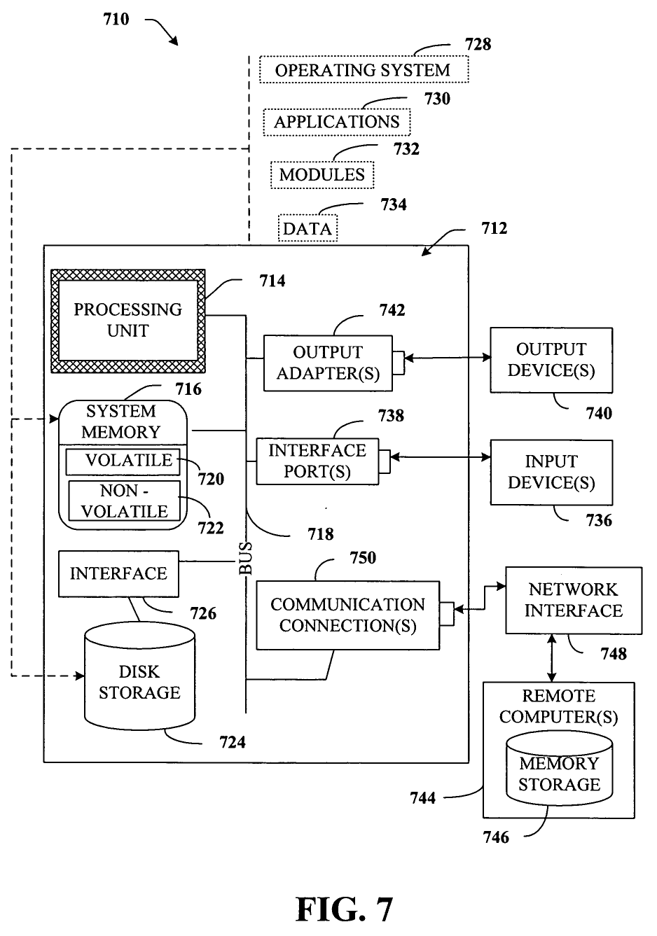

In order to provide additional context for various aspects of the subject invention, FIG. 7 and the following discussion are intended to provide a brief, general description of a suitable operating environment 710 in which various aspects of the subject invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 710 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 7, an exemplary environment 710 for implementing various aspects of the invention includes a computer 712. The computer 712 includes a processing unit 714, a system memory 716, and a system bus 718. The system bus 718 couples system components including, but not limited to, the system memory 716 to the processing unit 714. The processing unit 714 can be any of various available processors. Dual microprocessors and other multiprocessor architectures also can be employed as the processing unit 714.

The system bus 718 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 716 includes volatile memory 720 and nonvolatile memory 722. The basic input/output system (BIOS), containing the basic routines to transfer information between elements within the computer 712, such as during start-up, is stored in nonvolatile memory 722. By way of illustration, and not limitation, nonvolatile memory 722 can include read only memory (ROM), programmable ROM (PROM), electrically programmable ROM (EPROM), electrically erasable ROM (EEPROM), or flash memory. Volatile memory 720 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 712 also includes removable/nonremovable, volatile/nonvolatile computer storage media. FIG. 7 illustrates, for example a disk storage 724. Disk storage 724 includes, but is not limited to, devices like a magnetic disk drive, floppy disk drive, tape drive, Jaz drive, Zip drive, LS-100 drive, flash memory card, or memory stick. In addition, disk storage 724 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 724 to the system bus 718, a removable or non-removable interface is typically used such as interface 726.

It is to be appreciated that FIG. 7 describes software that acts as an intermediary between users and the basic computer resources described in suitable operating environment 710. Such software includes an operating system 728. Operating system 728, which can be stored on disk storage 724, acts to control and allocate resources of the computer system 712. System applications 730 take advantage of the management of resources by operating system 728 through program modules 732 and program data 734 stored either in system memory 716 or on disk storage 724. It is to be appreciated that the subject invention can be implemented with various operating systems or combinations of operating systems.

A user enters commands or information into the computer 712 through input device(s) 736. Input devices 736 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 714 through the system bus 718 via interface port(s) 738. Interface port(s) 738 include, for example, a serial port, a parallel port, a game port, and a universal serial bus (USB). Output device(s) 740 use some of the same type of ports as input device(s) 736. Thus, for example, a USB port may be used to provide input to computer 712, and to output information from computer 712 to an output device 740. Output adapter 742 is provided to illustrate that there are some output devices 740 like monitors, speakers, and printers among other output devices 740 that require special adapters. The output adapters 742 include, by way of illustration and not limitation, video and sound cards that provide a means of connection between the output device 740 and the system bus 718. It should be noted that other devices and/or systems of devices provide both input and output capabilities such as remote computer(s) 744.

Computer 712 can operate in a networked environment using logical connections to one or more remote computers, such as remote computer(s) 744. The remote computer(s) 744 can be a personal computer, a server, a router, a network PC, a workstation, a microprocessor based appliance, a peer device or other common network node and the like, and typically includes many or all of the elements described relative to computer 712. For purposes of brevity, only a memory storage device 746 is illustrated with remote computer(s) 744. Remote computer(s) 744 is logically connected to computer 712 through a network interface 748 and then physically connected via communication connection 750. Network interface 748 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 750 refers to the hardware/software employed to connect the network interface 748 to the bus 718. While communication connection 750 is shown for illustrative clarity inside computer 712, it can also be external to computer 712. The hardware/software necessary for connection to the network interface 748 includes, for exemplary purposes only, internal and external technologies such as, modems including regular telephone grade modems, cable modems and DSL modems, ISDN adapters, and Ethernet cards.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A strongly-typed classification system that facilitates automation of UI comprising:
a data extraction component that extracts data from a dialog; and
a class generator component that automatically generates a strongly-typed class based at least in part on the data extracted from the dialog.

2. The system of claim 1, further comprising a code generator component that generates code automatically based on the data extracted from the dialog for the designated strongly-typed class.

3. The system of claim 1, further comprising an AI component that is trained to learn from mistakes, errors, or successes to optimize generation of the strongly-typed class.

4. The system of claim 1, further comprising an analysis component that examines the data extracted from the dialog which facilitates generating the strongly typed class for the dialog.

5. The system of claim 1, the dialog comprises a plurality of UI elements.

6. The system of claim 1, the dialog comprises at least one of the following:
a textbox;
a checkbox;
a radio button;
a combo box;
an edit combo box;
a browse button; and
a functional button.

7. The system of claim 6, the functional button performs an action when pressed or clicked.

8. The system of claim 1, further comprising a code post processor component that comprises at least one of the following:
a component that removes blank lines from the code;
a component that organizes the code into regions according to its logical parts; and
a component that adds one or more comments to the code.

9. The system of claim 1, the strongly-typed class comprises one or more properties to facilitate access to one or more controls, wherein the properties are named based in part on labels found surrounding the controls.

10. The system of claim 1, the data extracted from the dialog comprises controls, control IDs, control types, location of the controls, and resource IDs.

11. The system of claim 1, the code is generated in a plurality of languages based in part on user preferences.

12. The system of claim 1, further comprising a library that stores a plurality of strongly-typed classes and from which class information can be referenced to facilitate generating the strongly-typed class for the dialog.

13. The system of claim 1, further comprising a matching component that finds a closest match between a window class and a control from the dialog to facilitate generating a strongly-typed class for the dialog.

14. The system of claim 1, further comprising an interface component that points to a dialog for which automation is desired to initiate the strongly-typed classification.

15. A method that facilitates strongly typed UI automation comprising:
selecting one or more UI elements for automation;
finding an ancestor window corresponding to the UI elements;
traversing one or more controls in the window to obtain data; and
generating a strongly-typed class based on the data.

16. The method of claim 15, further comprising extracting the data, the data comprising at least one of control IDs, control types, control locations, fields, boxes, and buttons.

17. The method of claim 15, further comprising selecting one or more subdirectories to obtain the data, the data comprising resource IDs.

18. The method of claim 15, the strongly-typed class identifies control types by analyzing groups of sub-controls.

19. The method of claim 15, the strongly typed class comprises a plurality of properties to facilitate accessing one or more controls.

20. The method of claim 19, further comprising naming the properties by looking for associated labels surrounding the respective controls.

21. The method of claim 15, further comprising generating code in an automated fashion for the strongly-typed class.

22. The method of claim 21, further comprising beautifying the code by performing at least one of the following:
organizing the code into regions based on its logical parts;
adding comments; and
removing blank lines.

23. A data packet adapted to be transmitted between two or more computer processes facilitating automation of UI elements via strongly-typed classification, the data packet comprising: information associated with selecting a dialog for automation, extracting and analyzing one or more controls from the dialog to determine control-class associations, and generating a strongly-typed class and its corresponding code automatically.

24. A computer readable medium having stored thereon the computer executable components of claim 1.

25. A system that facilitates strongly typed UI automation comprising:
means for selecting one or more UI elements for automation;
means for finding an ancestor window corresponding to the UI elements;
means for traversing one or more controls in the window to obtain data; and
means for generating a strongly-typed class based on the data.
